(19) United States
(12) Patent Application Publication
(10) Pub. No.: US 2009/0076921 A1
(43) Pub. Date: Mar. 19, 2009

(54) POINT OF SALE DEVICE WITH CARD READER AND CHECK SCANNER

(75) Inventors: Eric Nelson, Waterloo, NE (US); James Price, Alpharetta, GA (US); Hugh McCormack, Winder, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/855,931

(22) Filed: Sep. 14, 2007

(51) Int. Cl. G06Q 30/00

(52) U.S. Cl. 705/16

(57) ABSTRACT

Various improved features for a point of sale (POS) device are disclosed. The POS device may have a housing, a document path, a check-voiding printer, and a door in the housing enabling access through the document path to the check-voiding printer. The POS device may have a connector and cavity in its interior, not visible from the exterior, the cavity configured to hold an accessory device connected to the connector. The POS device may comprise a read head for reading characters printed in magnetic ink on the face of a check and a biasing mechanism that has a contacting face that holds the check against the read head. The POS device may have an opening in a back wall through which a check is at least partially visible during reading. The POS device may include two microprocessor systems that control different parts of the POS device.

### BACKGROUND OF THE INVENTION

A point of sale (POS) device is an electronic device that facilitates operations that a merchant often performs in conjunction with sale transactions. These operations may include, for example, check verification, credit card transaction approval, receipt printing, or other operations. A POS device may comprise a reader for credit and debit cards or other presentation instruments, a printer for printing receipts, one or more communications interfaces for receiving approvals over a communications network, or other subsystems.

One example of such a POS device is the model FD100 Point-of-Sale System available from First Data Corporation of Greenwood Village, Colo., USA.

For some businesses, a POS device may process the majority of the firm's sale transactions. In order to avoid interruptions in the ability of the business to make sales, and in order to avoid frustrating delays for consumers wishing to make purchases, it is important that a POS device operate smoothly, quickly, and reliably.

### BRIEF SUMMARY OF THE INVENTION

In one embodiment, a point of sale (POS) device comprises a housing, a document path, a check-voiding printer, and a document path door that enables access through the document path to the check-voiding printer. In some embodiments, the check-voiding printer may be an inkjet printer comprising an inkjet printhead, and access to the check-voiding printer may comprise access for changing the inkjet printhead. In some embodiments, the POS device may further comprise a printhead door that, when actuated, swings the inkjet printhead from the interior toward the exterior of the POS device. In some embodiments, the printhead door may be latched using a push-push mechanism.

In another embodiment, a POS device comprises a connector in the interior of the POS device, so as to be covered by the housing of the POS device, and a cavity configured to hold an accessory connected to the connector. In some embodiments, the connector may be a universal serial bus (USB) port connector. In some embodiments, the POS device may further comprise a door in the housing, the door concealing the cavity and the connector. In some embodiments, a tool may be required for removing the door. In some embodiments, the POS device may comprise an accessory connected to the connector. In some embodiments, the accessory may be a wireless module enabling cellular telephone communication, a dongle enabling wireless network communication, or another kind of device.

In another embodiment, a POS device comprises a read head configured to read characters printed in magnetic ink on the face of a check, a transport mechanism, and a biasing mechanism that comprises a contacting face that holds the face of the check against the read head. In some embodiments, the shape of the contacting face may be selected to minimize stress concentrations. In some embodiments, the read head may have a generally convex face and the contacting face may be generally concave, such that the check is wrapped against the convex read head face during reading. In some embodiments, the biasing mechanism may be a cantilevered spring, and may be made of plastic or another material. In some embodiments, the contacting face may have a generally hexagonal shape.

In another embodiment, a POS device comprises a housing, a check reader, a slot that wraps at least partially around the back of the POS device, a back wall forming one side of the slot at the back of the POS device, and an opening in the back wall. In some embodiments, the opening may be configured to enable clearing of a paper jam occurring during check reading. In some embodiments, the opening may be configured to enable cleaning of the check reader. In some embodiments, the POS device may be configured to read checks of various sizes, and at least some part of a check being read is visible from the exterior of the POS device at all times during reading, regardless of the size of the check.

In another embodiment, a POS device comprises a presentation instrument reader for reading information from presentation instruments, a first microprocessor system that controls the presentation instrument reader, a document transport, and a second microprocessor system that controls the document transport. In some embodiments, the POS device may comprise a keypad or a host interface controlled by the first microprocessor system. In some embodiments, the two microprocessor systems may reside on separate circuit boards. In some embodiments, the two microprocessor systems may be able to communicate with each other.

In another embodiment, a method comprises opening a door in a housing of a POS device, the housing defining an interior and an exterior of the POS device, the POS device comprising a document path in which a check is fed for scanning, a face of the check facing the interior of the POS device during scanning, the POS device further comprising a check-voiding printer substantially contained in the interior of the POS device, the check-voiding printer configured to print on the face of the check, and accessing the check-voiding printer through the door and through the document path. In some embodiments, the printer may be an inkjet printer comprising an inkjet printhead. In some embodiments, the method may further comprise changing the inkjet printhead, accessing the inkjet printhead through the door and through the document path. In some embodiments, the method may further comprise actuating a printhead door, actuating the printhead door swinging the printhead from the interior toward the exterior of the POS device.

### BRIEF DESCRIPTION OF THE DRAWINGS

FIG. 1 depicts a point of sale (POS) device in accordance with an example embodiment of the invention.

FIG. 2 depicts a POS device in accordance with another example embodiment of the invention.

FIG. 3 shows an enlarged view of a portion of the POS device of FIG. 2.

FIG. 4 shows the POS device of FIG. 2 with some internal parts exposed.

FIG. 5 shows a POS device in accordance with another example embodiment of the invention.

FIG. 6 shows a cutaway view of the POS device of FIG. 5.

FIG. 7 depicts a portion of a POS device in accordance with another example embodiment of the invention.

FIG. 8 shows a top view of a portion of the POS device of FIG. 7.

FIG. 9 depicts a POS device in accordance with another example embodiment of the invention.

FIG. 10 depicts an internal electronic architecture of a POS device, in accordance with an example embodiment of the invention.

### DETAILED DESCRIPTION OF THE INVENTION

In one embodiment, a point of sale (POS) device comprises a housing, a document path, a check-voiding printer, and a document path door that enables access through the document path to the check-voiding printer. Except where specifically claimed otherwise, many variations of these elements are possible. The housing may be made of any suitable material, for example metal, plastic, or another material, or a combination of materials. The housing may be made of one piece, or of multiple pieces that fit together to form the complete housing. Different pieces may be made of different materials. The document path may hold a check in a horizontal or vertical orientation. In some embodiments, the check-voiding printer may be an impact printer, a toner-based printer, a dot-matrix printer, a laser printer, or another kind of printer. The printer may print in a single color or in multiple colors. In some embodiments, the check-voiding printer may be an inkjet printer comprising an inkjet printhead, and access to the check-voiding printer may comprise access for changing the inkjet printhead, troubleshooting and repair of the check-voiding printer, or other tasks. In some embodiments, the POS device may further comprise a printhead door that, when actuated, swings the inkjet printhead from the interior toward the exterior of the POS device. In some embodiments, the printhead door may be latched using a push-push mechanism, or in other embodiments, another kind of latch may be used, such as a magnetic catch, a mechanical catch, or another kind of latch. The document path door or the printhead door or both may be attached using a hinge or flap, or may be removable.

In another embodiment, a POS device comprises a connector in the interior of the POS device, so as to be covered by the housing of the POS device, and a cavity configured to hold an accessory connected to the connector. In some embodiments, the connector may be a USB port connector, a serial connector, a parallel connector, a standard connector, a proprietary connector, or another kind of connector. In some embodiments, the POS device may further comprise a door in the housing, the door covering and possibly concealing the cavity and the connector. In some embodiments, the door may be attached to the housing by a screw, bolt, clip, latch, or other fastener, and one or more tools may be required for removing the door. In some embodiments, the POS device may comprise an accessory connected to the connector. In some embodiments, the accessory may be a wireless module enabling cellular telephone communication, may be a dongle enabling wireless network communication, may provide additional memory for the POS device, or may provide timekeeping, monitoring, security, or other functionality to the POS device.

In another embodiment, a POS device comprises a read head configured to read characters printed in magnetic ink on the face of a check, a transport mechanism, and a biasing mechanism that comprises a contacting face that holds the face of the check against the read head. The read head may comprise a magnetic reader, or may read the characters optically. The POS device may perform optical character recognition (OCR) in order to interpret the characters. The POS device may scan an image of the check, using a contact image scanner (CIS), a lens reduction scanner, a camera, or another kind of imaging device. Except where specifically claimed otherwise, the biasing mechanism may be made of any suitable material, including a metal, such as spring steel, a plastic, such as glass-reinforced polycarbonate, or any other suitable material or combination of materials. The transport mechanism may move a document through the POS device using a stepper motor, a DC servo motor, or another source of motive power. The transport mechanism may also comprise various rollers, idlers, sensors, guides, or other components. In some embodiments, the shape of the contacting face may be selected to minimize stress concentrations. In some embodiments, the read head may have a generally convex face and the contacting face may be generally concave, such that the check is wrapped against the convex read head face during reading. In some embodiments, the biasing mechanism may be a cantilevered spring, and may be made of plastic or another material. In some embodiments, the contacting face may have a generally polygonal shape, which may be hexagonal.

In another embodiment, a POS device comprises a housing, a check reader, a slot that wraps at least partially around the back of the POS device, a back wall forming one side of the slot at the back of the POS device, and an opening in the back wall. The slot may be molded into the housing of the POS device, or may be formed by joining parts together. In some embodiments, the opening may be configured to enable clearing of a paper jam occurring during check reading, for example by inserting a finger or other object into the opening to contact and move the jammed paper. In some embodiments, the opening may be configured to enable cleaning of the check reader, for example by directing compressed air into the check reader through the slot. In some embodiments, the POS device may be configured to read checks of various sizes, and at least some part of a check being read is visible from the exterior of the POS device at all times during reading, regardless of the size of the check.

In another embodiment, a POS device comprises a presentation instrument reader for reading information from presentation instruments, a first microprocessor system that controls the presentation instrument reader, a document transport, and a second microprocessor system that controls the document transport. The presentation instrument reader may comprise a magnetic stripe reader, a bar code reader, a radio frequency (RF) reader, a near-field communications (NFC) reader, or any combination of these or other kinds of readers. The presentation instrument reader may be configured to read credit cards, debit cards, stored-value cards, gift cards, electronic wallets, or other kinds of presentation instruments. In some embodiments, the POS device may comprise a keypad or a host interface or other subsystems controlled by the first microprocessor system. The two microprocessor systems may reside on separate circuit boards or on the same circuit board. The microprocessor systems may comprise one or more single-chip computers, digital signal processors, microprocessors, or other kinds of processors. Either or both microprocessor systems may run a standard operating system such as Windows CE® available from Microsoft Corporation of Redmond, Wash., USA, or either or both microprocessors may run a proprietary operating system. In some embodiments, the two microprocessor systems may be able to communicate with each other, for example through a universal serial bus (USB) interface, a serial interface, a parallel interface, a standard interface, a proprietary interface, or through another kind of connection.

In another embodiment, a method comprises opening a door in a housing of a POS device, the housing defining an interior and an exterior of the POS device, the POS device comprising a document path in which a check is fed for scanning, a face of the check facing the interior of the POS device during scanning, the POS device further comprising a check-voiding printer substantially contained in the interior of the POS device, the check-voiding printer configured to print on the face of the check, and accessing the check-voiding printer through the door and through the document path. In some embodiments, the printer may be an inkjet printer comprising an inkjet printhead, a laser printer, an impact printer, a dot-matrix printer, or another kind of printer. The printer may print in a single color or in multiple colors. Opening the door in the housing may comprise swinging the door on a hinge or flap, removing the door, or opening the door by another means. Accessing the check-voiding printer may include changing a printhead, ribbon, or toner supply, cleaning the printer mechanism, or other kinds of access. In some embodiments, the method may further comprise actuating a printhead door, the actuating of the printhead door swinging a printhead from the interior toward the exterior of the POS device. The printhead door may be attached using a hinge, flap, or other device, and may be latched using a magnetic catch, a mechanical catch, a push-push mechanism, or another kind of latch.

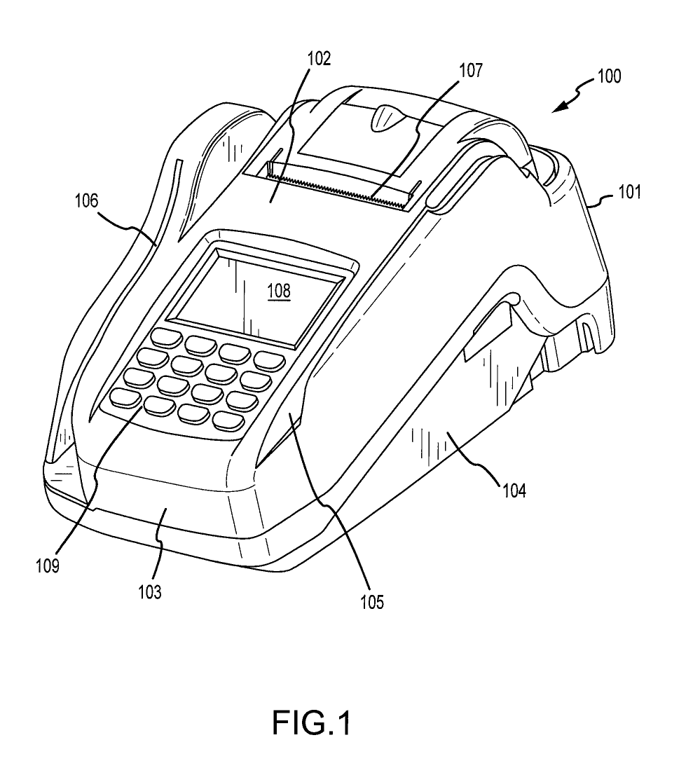

Turning now to the figures, FIG. 1 depicts a point of sale (POS) device 100 in accordance with an example embodiment of the invention. Visible in FIG. 1 is a housing 101, which defines the configuration of the POS device, including a top 102, front 103, and side 104. Not visible in FIG. 1 are a back of the POS device generally opposite the front, and a second side generally opposite the first. The terms top, front, back, and sides are to be understood in a general sense, and do not imply that the POS device is strictly rectangular. Housing 101 also defines the exterior shape of the POS device, and encloses an interior of the device. Housing 101 may be formed of one or more than one piece, for example of molded plastic parts that fit together to form the complete housing. Housing 101 may be made of any suitable material, for example metal or plastic, or from a combination of materials, for example a combination of plastic and metal parts. Ordinarily, the front 103 and top 102 of POS device 100 will face the user of the device.

POS device 100 comprises a presentation instrument reader for reading information from presentation instruments. A presentation instrument is a financial instrument offered for payment by presenting it. Examples of presentation instruments include credit cards, debit cards, pre-paid cards, stored-value cards, gift cards, electronic wallets, or other kinds of instruments. In example POS device 100, the presentation instrument reader is configured to read information magnetically encoded on a credit, debit, or other type of card when the card is swiped though credit card slot 105 near side 104. POS device 100 also comprises a check reader for reading magnetic ink character recognition (MICR) characters from the face of a check fed through check reading slot 106 near the opposite side of POS device 100. The check reader may include a magnetic sensor, or may scan the characters optically and interpret them using optical character recognition. Other features comprised in POS device 100 may include a receipt printer 107 for printing sales receipts and other documents, a display 108 for communicating information to a user of the device, a scanner for scanning an image of a check, and a keypad 109 for accepting user input, for example a telephone number to call for check verification. Other aspects of POS device 100 will be described below. It is not necessary that a POS device in accordance with one example embodiment described or claimed herein comprise all of the features and aspects of all of the described embodiments.

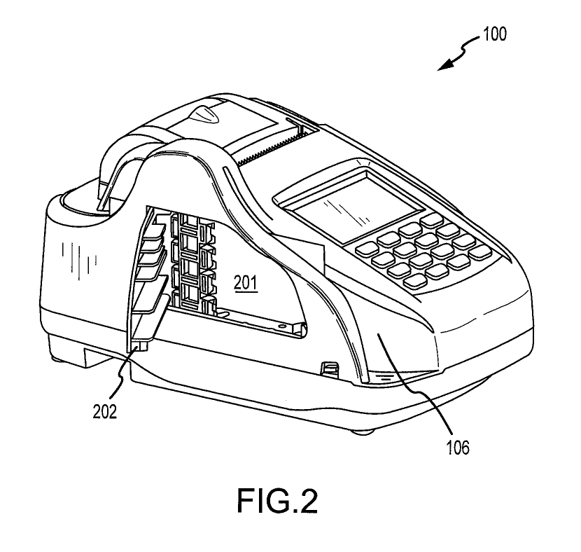

FIGS. 2-4 show POS system 100 in accordance with another example embodiment of the invention. Referring first to FIG. 2, a check 201 is traversing a document path that comprises slot 106. The back of check 201 is visible in FIG. 2. The face of check 201, upon which a customer writes payment information, is opposite the back of the check and is facing the interior of POS device 100. POS system 100 may comprise a device for scanning check 201, for example an image scanner for scanning an image of check 201, or a MICR reader for reading account and bank information magnetically printed on the face of check 201. Scanning occurs while check 201 is fed through the document path. Door 202 is normally closed during scanning, but is shown open in FIG. 2 for clarity. Preferably, check 201 is moved through the document path by a motorized document transport mechanism. Further explanation of character recognition and image scanning can be found in U.S. Pat. No. 6,547,132 to Templeton, et al. titled “Point of Sale Payment Terminal”, the entire disclosure of which is hereby incorporated by reference.

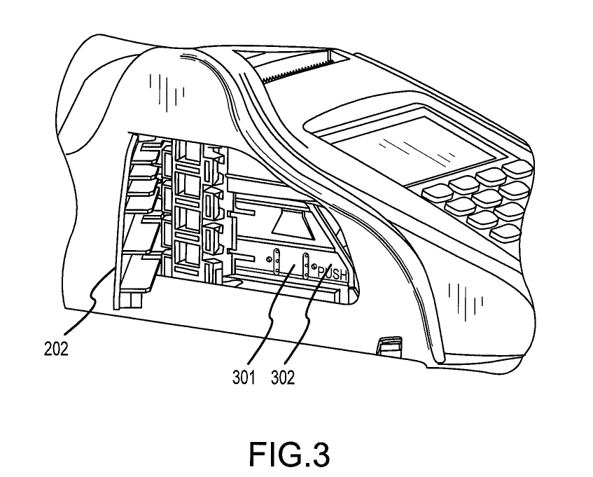

FIG. 3 shows an enlarged view of a portion of FIG. 2, with check 201 removed. FIG. 3 shows part of a check-voiding printer 301, contained in the interior of POS device 100 and configured to print on the face of a check in the document path. Check-voiding printer 301 is accessible through door 202. Also visible in FIG. 3 is printhead door 302, labeled “Push” in this example embodiment.

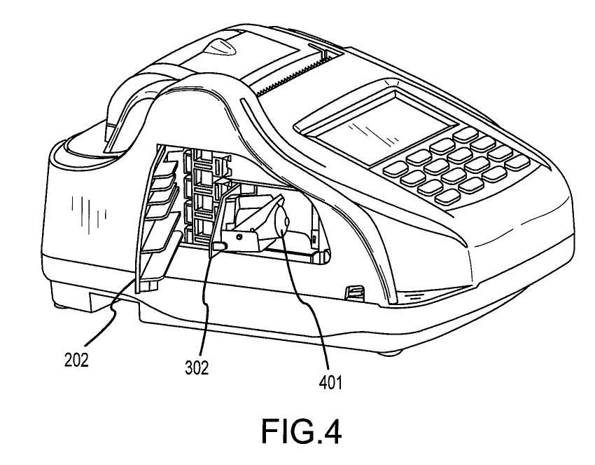

FIG. 4 depicts POS device 100 with both door 202 and printhead door 302 open. In this example embodiment, check-voiding printer 301 is an inkjet printer, and comprises an inkjet printhead 401. Inkjet printhead 401 contains ink that is used to print on the face of checks in the document path. As printhead 401 contains a finite supply of ink, it may require replacement. Printhead 401 is mounted to printhead door 302, and when printhead door 302 is actuated, printhead 401 is swung from the interior of POS device 100 toward the exterior. This motion makes inkjet printhead 401 accessible for replacement.

Preferably, printhead door 302 is latched using a “push-push” mechanism. Push-push mechanisms are well known, and have the characteristic that both latching and unlatching are accomplished by pushing on the door from the same side. That is, printhead door 302 may be latched closed by pushing on the outside surface, and may subsequently be opened by pushing on the same surface, the push-push mechanism holding the door in the closed position or using a spring to assist in opening the door.

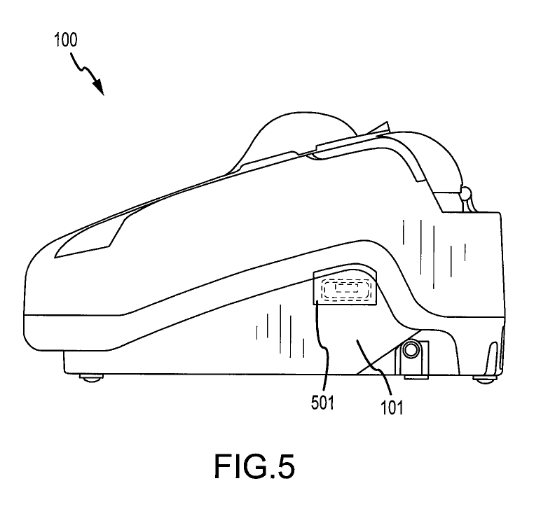

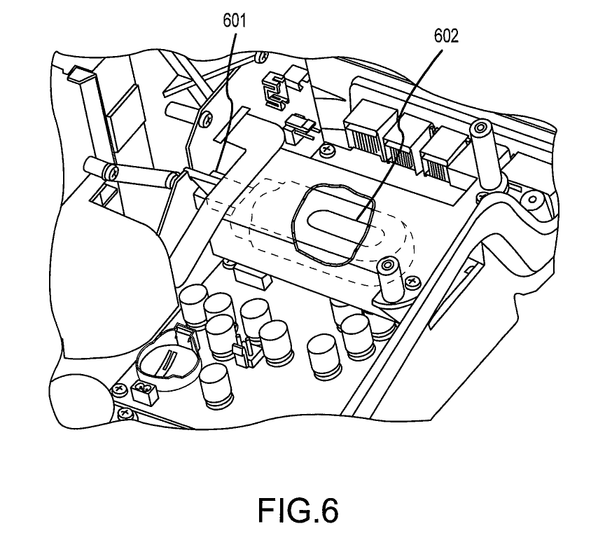

FIGS. 5 and 6 depict a POS device 100 in accordance with another example embodiment of the invention. Referring first to FIG. 5, POS device 100 comprises a door 501, which conceals a hidden cavity and connector that are covered by housing 101 and not normally visible from the exterior of POS device 100. Preferably, door 501 is secured using a screw or other fastener so that at least one tool is required to remove it from the side of POS device 100.

FIG. 6 shows a cutaway view of POS device 100. Hidden connector 601 is visible in this cutaway view. Connector 601 may be a USB connector, a serial port connector, a proprietary connector, or another kind of connector suitable for connecting an electronic device. A USB connector has the advantage that it provides an industry-standard interface and can provide a moderate amount of electrical power to a device plugged into it. Also visible in FIG. 6 is an accessory 602 connected to hidden connector 601. The hidden cavity and hidden connector 601 provide a convenient means for enabling optional features of POS device 100 or for enabling upgrading POS device 100 by plugging in appropriate accessories 602.

Accessory 602 may be any device useful to the operation of POS device 100. For example, accessory 602 may be a wireless dongle that enables a wireless network connection to a computer that works in concert with POS device 100. Such a feature is not needed by every merchant, for example one with a wired network connection already available at the point of sale, but could be very useful for a merchant who wishes to place POS device 100 relatively far from a computer and doesn't wish to run additional wiring to the POS device location.

In another example embodiment, accessory 602 enables cellular telephone capability in POS device 100. Such a capability may be especially useful to a merchant who wishes to use the POS device at a trade show, flea market, or other location where wired telephone or network service is not readily available. A cellular telephone connection could dial credit card or check approval numbers directly, or could provide an Internet connection, for example using a wireless access protocol. In this configuration, POS device 100 may be used at any location with cellular telephone service and available electrical power. Accessory 602 may provide other functions in place of or in addition to those already described. For example, accessory 602 may provide additional memory to POS device 100, may provide advanced time keeping functionality, testing or monitoring functionality, or other functions.

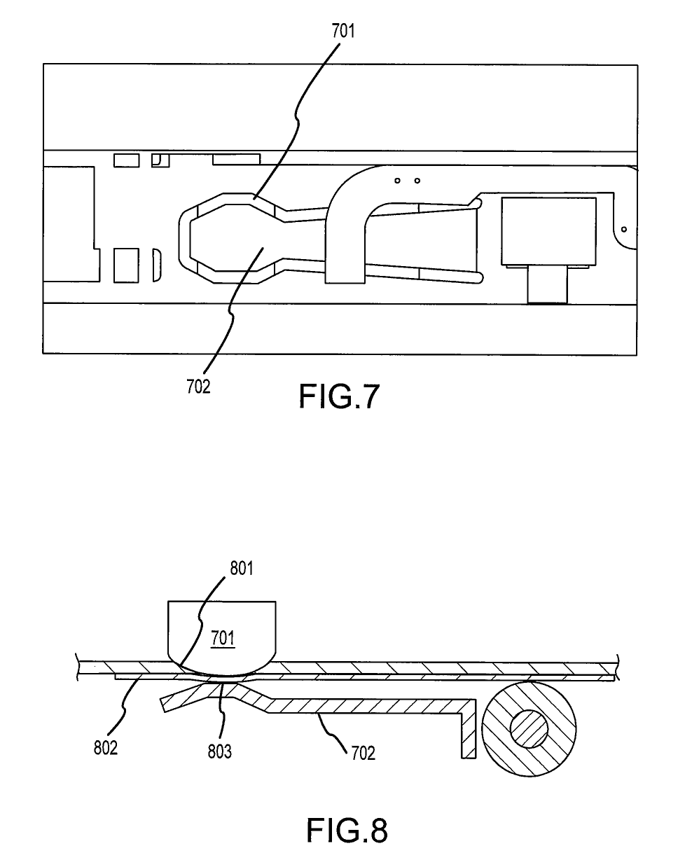

FIGS. 7 and 8 depict a portion of a POS device 100 in accordance with another example embodiment of the invention. POS device 100 comprises a read head 701 configured to read characters printed in magnetic ink on the face of a check. For example, read head 701 may be positioned adjacent the document path similar to the path depicted in FIG. 2. The characters printed in magnetic ink are sometimes referred to as MICR characters. An example biasing mechanism in the form of cantilevered spring 702 holds a check against read head 701. Spring 702 is preferably made of molded plastic, but may be made of another material, such as spring steel.

FIG. 8 shows a top view of the read head and spring of FIG. 7. Read head 701 preferably has a convex reading face 801. During scanning, a check 802 is pressed against read head 701 by a contacting face 803 on cantilevered spring 702. The result is that check 802 is held firmly in contact with read head 701, facilitating reliable reading of the MICR characters. In this example embodiment, contacting face 803 is concave and complementary to reading face 701, resulting in check 802 being somewhat wrapped onto reading face 801.

A common problem with plastic springs is that many plastic materials are subject to creep when held under stress, resulting in a degradation of the applied spring force over time. This problem is especially acute when the design of the spring results in stress concentrations. Preferably, contacting face 803 has a shape selected to minimize stress concentrations and enhance the performance of cantilevered spring 702 over its life. In some embodiments, the face 803 may be generally polygonal in shape, and in one example embodiment may be generally hexagonal.

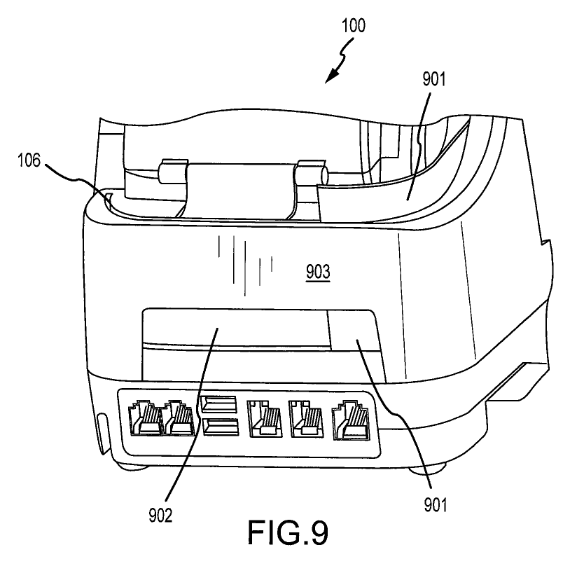

FIG. 9 depicts a POS device 100 in accordance with another example embodiment of the invention. In FIG. 9, a check 901 is being fed through a document path similar to that depicted in FIG. 2. Check 901 rides in slot 106 near the front and side of POS device 100, and which wraps around the back of POS device 100.

Point of sale device 100 may be configured to read checks of many different sizes. For example, “personal size” checks often used by customers for personal purchases are often approximately 70×152 millimeters, while business checks are often about 89×216 millimeters. Other sizes are possible as well. Having slot 106 wrap around the back of POS device 100 allows checks of relatively large size to pass entirely by a check reader or scanner without encountering the end of the slot. The back of POS device 100 comprises a back wall 903. In this example embodiment, back wall 903 has an opening 902, which exposes at least part of check 901 during at least part of a check reading cycle.

Opening 902 helps ensure that at all times during the reading or scanning of check 901, and regardless of the size of check 901, at least some part of check 901 is visible from the exterior of POS device 100. In other words, while no particular part of check 901 is necessarily exposed during the entire reading cycle, at no time during a reading cycle is check 901 completely hidden from view. In the unlikely event of a paper jam, opening 902 may provide access to check 901 for clearing the jam. Furthermore, opening 902 provides access for cleaning of slot 106. Preferably opening 902 is large enough so that a user of POS device 100 can access the check by inserting a finger through opening 902. For example, opening 902 may be approximately 10 to 30 millimeters high and extend across the majority of the back of POS device 100. Other configurations and sizes are possible as well.

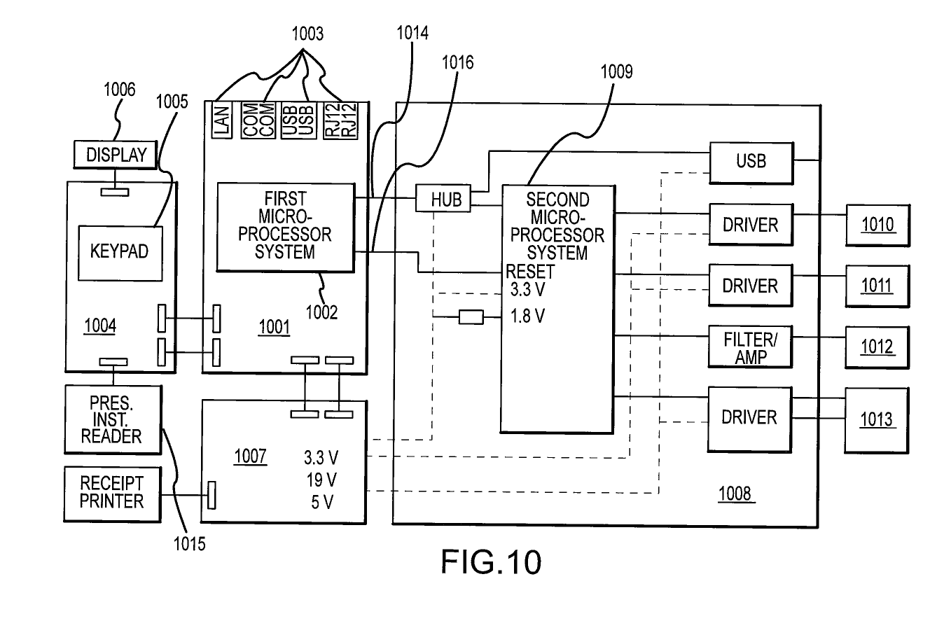

FIG. 10 depicts an internal electronic architecture of a POS device in accordance with an example embodiment of the invention. This architecture may be comprised in any of the example POS devices so far described, or in another POS device. In this example arrangement, the electronics of the POS device are comprised on four separate printed circuit boards. One of skill in the art will recognize that more or fewer boards could be used, and that certain subsystems now residing on two separate boards could be combined onto a single board. For the purposes of this disclosure a “circuit board” encompasses a rigid, semi-rigid, or flexible substrate comprising interconnections for electronic components mounted on the substrate.

A motherboard 1001 comprises a first microprocessor system 1002. For the purposes of this disclosure, a microprocessor system is a set of components that perform computation and control. A microprocessor system comprises a CPU, memory, and an input/output capability. The memory may comprise volatile memory such as random access memory (RAM), nonvolatile memory such as read only memory (ROM) or flash memory, or a combination of these. The input/output capability may comprise at least one signal or port, and may comprise a large number of signals, ports, or a combination of these. A microprocessor system may be integrated into a single integrated circuit, or may comprise more than one integrated circuit. A microprocessor system may reside on a single circuit board or may distributed across multiple circuit boards.

Example motherboard 1001 further comprises several input/output connectors 1003. Input/output connectors 1003 may comprise a local area network (LAN) connection, one or more communications (COM) ports, one or more universal serial bus (USB) ports, and one or more RJ12 connectors for connecting to telephone equipment or the like. More or fewer connectors may be used, and other kinds of connections may be envisioned.

Motherboard 1001 connects to user interface board 1004, which comprises (or comprises connections to) one or more user interface devices under the control of first microprocessor system 1002. Example user interface board 1004 comprises a keypad 1005, and comprises connections to a display 1006 and a presentation instrument reader 1015. More, fewer, or other user interface devices may be included. While only two lines are shown connecting motherboard 1001 with user interface board 1004, it will be understood that these lines represent multiple wiring connections that carry power and ground connections, and communications signals that may be digital, analog, or a combination of these.

A power board 1007 supplies electrical power, at appropriated voltages, to the other boards. The power is derived from an external source not shown.

A document transport board 1008 comprises a second microprocessor system 1009. In this example embodiment, second microprocessor system 1009 controls several electromechanical subsystems of POS device 100, including a check-voiding printer 1010, a document transport comprising step motor 1011, a MICR reader 1012 that reads MICR characters from a check face, and an image scanner 1013. More or fewer such devices may be included. Document transport board 1008 receives power from power board 1007. The document transport may also comprise various rollers, guides, sensors, and such for moving a check past, for example, check-voiding printer 1010, MICR reader 1012, scanner 1013. Preferably, the document transport is bi-directional, so that a check is transported both in and out of POS device 100. Scanning, reading, or both may be performed as the check is moving in either direction, or both directions. Likewise, printing may be performed as the check is moving in either direction, or both directions.

POS device 100 may include other kinds of readers or scanners. For example POS device 100 could include a bar code reader, a radio-frequency (RF) reader, a near field communication (NFC) reader, or another kind of reader. Scanner 1013 may be a contact image sensor (CIS) scanner, a reduction optics scanner, an array scanner or camera, or another kind of scanner.

Document transport board 1008 also connects to motherboard 1001. In this example, at least part of the connection is made through a USB interface 1014, although other interfaces are possible. In this example embodiment, a reset signal 1016 is also provided between first microprocessor system 1002 and second microprocessor system 1009. In this configuration, document transport board 1008 appears as a peripheral to motherboard 1001. Communications across USB interface 1014 can comprise relatively high-level commands and results, while second microprocessor system 1009 relieves first microprocessor system 1002 of the burden of low-level control of electromechanical devices 1010-1013. For example, first microprocessor 1002 may issue a command to scan a check and return the information found in the MICR characters on the face of the check. Second microprocessor 1009 performs such low-level operations as timing, counting, and issuing step pulses to step motor 1011, reading any document position sensors, and the like.

Because second microprocessor 1009 handles these low-level tasks, first microprocessor 1002 is free to control and communicate with the user interface devices on user interface board 1004, communicate over input/output connectors 1003, and the like. Because processing tasks are divided, POS device 100 can perform quickly, resulting in merchant productivity and avoiding customer delays. Furthermore, testing and repair operations are efficient because the various subsystems are relatively isolated. For example, a problem with the operation of check-voiding printer 1010 is unlikely to be caused by a component on motherboard 1001, so a technician diagnosing the check-voiding printer problem can concentrate his or her efforts on document transport board 1008.

The invention has now been described in detail for the purposes of clarity and understanding. However, those skilled in the art will appreciate that certain changes and modifications may be practiced within the scope of the appended claims.

What is claimed is:

1. A point of sale device, comprising:
a housing defining an interior and an exterior of the point of sale device;
a document path in which a check is fed for scanning, a face of the check facing the interior of the point of sale device during scanning;
a check-voiding printer substantially contained in the interior of the point of sale device, the check-voiding printer configured to print on the face of the check in the document path; and
a document path door in the housing, the door enabling access through the document path to the check-voiding printer.

2. The point of sale device of claim 1, wherein the check-voiding printer is an inkjet printer comprising an inkjet printhead.

3. The point of sale device of claim 2, wherein access to the check-voiding printer comprises access for changing the inkjet printhead.

4. The point of sale device of claim 2, further comprising a printhead door, accessible through the document path door, the printhead door configured to, when actuated, swing the inkjet printhead from the interior toward the exterior of the point of sale device.

5. The point of sale device of claim 4, further comprising a push-push latching mechanism that latches the printhead door.

6. A point of sale device, comprising:
a housing defining an interior and an exterior of the point of sale device;
a connector in the interior of the point of sale device, so as to be covered by the housing; and
a cavity within the interior of the point of sale device configured to hold an accessory connected to the connector.

7. The point of sale device of claim 6, wherein the connector is a USB port connector.

8. The point of sale device of claim 6, further comprising a door in the housing, the door concealing the cavity and the connector.

9. The point of sale device of claim 8, wherein at least one tool is required for removing the door.

10. The point of sale device of claim 6, further comprising an accessory connected to the connector.

11. The point of sale device of claim 10, wherein the accessory is a wireless module enabling cellular telephone communication.

12. The point of sale device of claim 10, wherein the accessory is a dongle enabling wireless network communication.

13. A point of sale device, comprising:
a read head configured to read characters printed in magnetic ink on a face of a check;
a transport mechanism for moving the check past the read head; and
a biasing mechanism that holds the face of the check against the read head during reading, the biasing mechanism further comprising a contacting face that contacts the check opposite the read head during reading;
wherein the contacting face has a shape selected to minimize stress concentrations in the biasing mechanism.

14. The point of sale device of claim 13, wherein the read head comprises a generally convex face that contacts the check face, and wherein the contacting face of the biasing mechanism is generally concave such that the check is wrapped against the convex read head face during reading.

15. The point of sale device of claim 13, wherein the biasing mechanism is a cantilevered spring is made of plastic.

16. The point of sale device of claim 13, wherein the contacting face has a generally hexagonal shape.

17. A point of sale device, comprising:
a housing defining a front, back, top, and two sides of the point of sale device;
a check reader;
a slot, near one side of the point of sale device, in which a check is transported during reading, the slot extending substantially along the length of one side and wrapping at least partially around the back of the point of sale device;
a back wall forming one side of the slot at the back of the point of sale device; and
an opening in the back wall through which the check is at least partially visible during at least part of reading.

18. The point of sale device of claim 17, wherein the opening in the back wall is configured to enable clearing of a paper jam occurring during check reading.

19. The point of sale device of claim 17, wherein the opening in the back wall is configured to enable cleaning of the check reader.

20. The point of sale device of claim 17, wherein the point of sale device is configured to read checks of various sizes, and wherein at least some part of a check being read by the point of sale device is visible from the exterior of the point of sale device at all times during reading, regardless of the size of the check.

21. A point of sale device, comprising:
a presentation instrument reader for reading information from a presentation instrument;
a first microprocessor system that controls the presentation instrument reader;
a document transport; and
a second microprocessor system that controls the document scanner.

22. The point of sale device of claim 21, further comprising a keypad, and wherein the first microprocessor system also controls the keypad.

23. The point of sale device of claim 21, further comprising a host interface, and wherein the first microprocessor system also controls the host interface.

24. The point of sale device of claim 21, wherein the two microprocessor systems reside on separate printed circuit boards.

25. The point of sale device of claim 21, wherein the two microprocessor systems can communicate with each other.
